(19) United States
(12) Patent Application Publication
(10) Pub. No.: US 2009/0213411 A1
(43) Pub. Date: Aug. 27, 2009

(54) PRINTING SYSTEM, PRINTING METHOD, COMPUTER, PRINTER AND DATA OUTPUTTING SYSTEM

(76) Inventor: KOICHI FUKUMI, Tokyo (JP)

Correspondence Address: NEC CORPORATION OF AMERICA, 6535 N. STATE HWY 161, IRVING, TX, 75039, US

(21) Appl. No.: 12/391,462

(22) Filed: Feb. 24, 2009

(30) Foreign Application Priority Data
Feb. 26, 2008 (JP) 44535/2008

(51) Int. Cl. G06K 15/00; G06F 3/12

(52) U.S. Cl. 358/1.14; 358/1.15

(57) ABSTRACT

A data outputting system includes a computer and an output apparatus which outputs data. The computer includes an intermediate file generating unit which converts a file of a processing object into an intermediate file which is in a form not depending on a model of the output apparatus. The output apparatus includes a data generating unit to convert the intermediate file into data which is in a form corresponding to a model of the output apparatus.

### INCORPORATION BY REFERENCE

This application is based upon and claims the benefit of priority from Japanese Patent Application No. 2008-044535, filed on Feb. 26, 2008, the disclosure of which is incorporated herein in its entirety by reference.

### BACKGROUND OF THE INVENTION

1. Technical Field

The present invention relates to a printing system, a printing method, a computer, a printer and a data outputting system.

2. Background Art

In recent years, a system, in which a terminal used by a user (client) has only a limited set of functions and a server manages resources such as application software and file, is applied to an information system of enterprise or the like. Such a system is called the thin client system. A terminal used by the client in the thin client system is called the thin client terminal.

According to the thin client system, the server unitarily manages all resources such as application software. For this reason, a low price computer having minimum functions limited to a display function, an input function or the like is available as the terminal used by user (thin client terminal). In other words, a complicated and expensive PC (Personal Computer) is unnecessary as the thin client terminal. As a result, it is possible to reduce cost of operation and management. The thin client system is very useful for an organization which needs many terminals.

However, a printing system based on the thin client system includes disadvantage to be settled. That is, for example, when a user changes a place where the user uses the thin client terminal, a model of a printer which is arranged at a place which the user moves to can be different from a model of a former printer which is arranged at the place which the user moves from. In such a case, if the thin client terminal includes no customized driver corresponding to the printer which is arranged at the place which the user moves to, a file cannot be printed by the printer without installation of the customized driver.

As a related art, Japanese Patent Application Laid-Open No. 2000-284928 (patent document 1) discloses a printing system.

According to the related art, the printing system includes a thin client, a printer, a server and a network which connects the apparatuses each other. The thin client has a data inputting unit which transmits print data to the server. The printer includes a printing unit which prints printer description language, a storage unit which stores printing capability information, a printing capability information receiving unit which receives the printing capability information and a printing capability registering unit which registers the printing capability information in the server. The server includes a print data converting unit which converts print data into the printer description language, a print data conversion information retrieving unit which retrieves conversion information, a conversion information providing unit which provides the conversion information, and a memory unit which stores the conversion information.

Japanese Patent Application Laid-Open No. 2006-244356 (patent document 2) discloses a printing apparatus and an information processing apparatus.

According to the related art, a host kernel of a printer controller carries out system call to a dynamic link library of a printer driver with respect to a printer driver processing flow which is carried out originally in the information processing apparatus. According to such a configuration, the driver process is carried out in the controller instead of the information processing apparatus and consequently, printing process is completed within the printing apparatus.

Japanese Patent Application Laid-Open No. 2006-350528 (patent document 3) discloses a printing system.

According to the related art, when a user prints a secret file which is stored in a server PC by using thin client defined on a client PC, meta information which does not depend on a printer is obtained from the server PC and transferred to the client PC, and afterward, printing is carried out by the client PC. Moreover, when the meta information is transferred from the server PC to the client PC, the meta information is encrypted in the server PC, and printing process is carried out in the client PC while the meta information is decrypted.

Japanese Patent Application Laid-Open No. 2007-122159 (patent document 4) discloses a printing system.

According to the related art, print data generated by a host computer which is host apparatus are transferred to a printer via a nonvolatile memory which is removal, and printing process is carried out by the printer. Specifically, control data for print control which is set by a print setting unit is transferred to the nonvolatile memory together with the print data which is generated by print application of the host computer. Afterward, the nonvolatile memory is attached to the printer, and then, the above-mentioned control data is read from the nonvolatile memory to carry out print control. For example, an automatic printing and print expiration date are set, and then, the print data generated by the host computer are printed by the printer through placing the nonvolatile memory so that security is ensured.

### SUMMARY

An exemplary object of the present invention is to provide a printing system, a printing method, a computer, a printer and a data outputting system, which enable a desired output apparatus to carry out processing without installing a driver corresponding to a model of output apparatus such as a printer, into a terminal apparatus, a server or the like.

A printing system according to an exemplary aspect of the invention includes:

a computer; and

a printer which prints print data,

wherein

the computer includes an intermediate file generating unit to convert a file of a printing object into an intermediate file which is in a form not depending on a printer model,

and wherein

the printer includes a print data generating unit to convert the intermediate file into print data which is in a form corresponding to a printer model.

A computer according to an exemplary aspect of the invention includes:

an intermediate file generating unit to convert a file of a printing object into an intermediate file which is in a form not depending on a printer model.

A printer according to an exemplary aspect of the invention includes:

a print data generating unit to convert a intermediate file which is in a form not depending on a printer model into print data which is in a form corresponding to a printer model.

A printing method according to an exemplary aspect of the invention includes:

converting a file of a printing object into an intermediate file which is in a form not depending on a printer model;

transmitting the intermediate file to a communication network; and

converting the intermediate file into print data which is in a form corresponding to a printer model; and printing the print data.

A data outputting system according to an exemplary aspect of the invention includes:

a computer; and

an output apparatus which outputs data,

wherein

the computer includes an intermediate file generating unit which converts a file of a processing object into an intermediate file which is in a form not depending on a model of the output apparatus,

and wherein

the output apparatus includes a data generating unit to convert the intermediate file into data which is in a form corresponding to a model of the output apparatus.

### BRIEF DESCRIPTION OF THE DRAWINGS

Exemplary features and advantages of the present invention will become apparent from the following detailed description when taken with the accompanying drawings in which:

FIG. 1 is a conceptual diagram showing a configuration of a printing system according to a first exemplary embodiment;

FIG. 2A is a block diagram showing an exemplary configuration of a data converting unit which compresses and encrypts a file;

FIG. 2B is a block diagram showing an exemplary configuration of the data converting unit which extracts and decrypts a file;

FIG. 3 shows an example of control information;

FIG. 4 is a flowchart showing operations according to the first exemplary embodiment;

FIG. 5 is a flowchart showing exemplary operations which are carried out when the number of times of printing remains;

FIG. 6 is a flowchart showing exemplary operations of a control information checking unit;

FIG. 7 is a flowchart showing exemplary operations of compression and encryption carried out by the data converting unit;

FIG. 8 is a flowchart showing exemplary operations of extraction and decryption carried out by the data converting unit;

FIG. 9 is a conceptual diagram showing a configuration of a printing system according to a second exemplary embodiment;

FIG. 10 is a flowchart showing operations according to the second exemplary embodiment;

FIG. 11 is a schematic diagram showing a configuration of a fourth exemplary embodiment; and

FIG. 12 is a block diagram showing a configuration according to a fifth exemplary embodiment.

### EXEMPLARY EMBODIMENT

Exemplary embodiments of the present invention will now be described in detail in accordance with the accompanying drawings.

### A FIRST EXEMPLARY EMBODIMENT

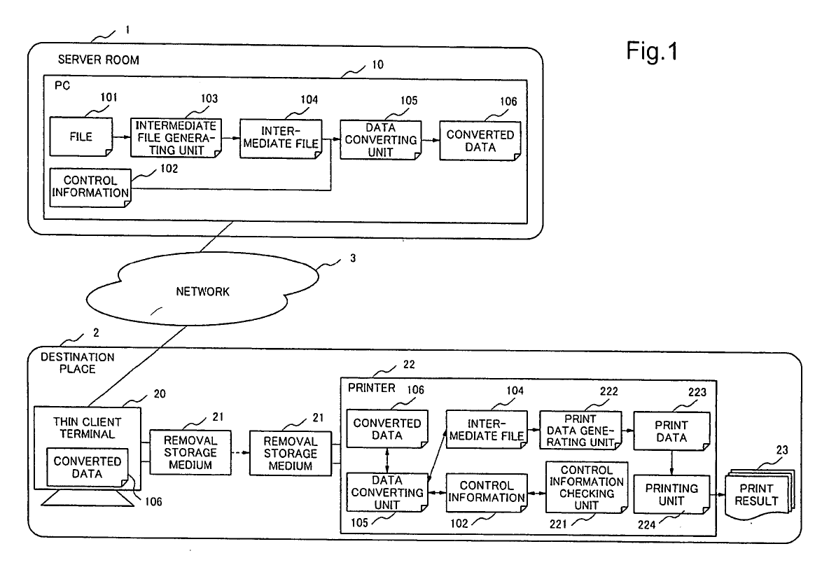

With reference to FIG. 1, a printing system according to the first exemplary embodiment includes a server room 1, a destination place 2 and a network 3.

The server room 1 is a place where a PC 10 is arranged as a thin client system. That is, the server room 1 includes at least one PC 10. Further, the server room 1 can be paraphrased with a group of servers including a plurality of PCs.

The PC 10 is used as a PC which works in the thin client system. Further, any type of PCs such as a blade PC and a virtual PC is applicable to the PC 10. That is, as an example of the PC 10, there is no limitation regarding a model of PCs. It is preferable that the PC 10 is a server working in the thin client system. The PC 10 is not limited to the examples above described.

The PC 10 includes a file 101, control information 102, an intermediate file generating unit 103, an intermediate file 104, a data converting unit 105 and converted data 106.

The file 101 is a file which a user wants to print. That is, the file 101 is a file to be printed. Further, the file 101 can be a file which is stored in the PC 10 in advance or a file which is transmitted from a thin client terminal 20 to the PC 10.

The control information 102 includes control information which is used when the file 101 is printed. Here, the control information includes expiration date, the number of times of printing and an ID (Identification information) of a printer which is permitted to print. However, the control information is not limited to the examples above mentioned. It is preferable that the control information 102 is set in advance. Further, the control information 102 may be set every time printing process is carried out.

The intermediate file generating unit 103 is a means for generating the intermediate file 104 based on the file 101.

The intermediate file 104 is in a form which does not depend on a model of a printer. PostScript (registered trademark) is one of examples of the form which does not depend on a model of a printer.

The data converting unit 105 is a means for converting (compressing and encrypting) the control information 102 and the intermediate file 104 to generate the converted data 106. Moreover, the data converting unit 105 also inversely converts (decrypts and extracts) the converted data 106 to regenerate the control information 102 and the intermediate file 104.

The control information 102 and the intermediate file 104 are converted (compressed and encrypted) by the data converting unit 105 and consequently, the converted data 106 is generated.

The destination place 2 is different in location from the server room 1. The destination place 2 is connected with the server room 1 via the network 3. Further, the destination place 2 can be paraphrased with a group of terminals working in the thin client system.

The destination place 2 includes the thin client terminal 20, a removal storage medium 21, a printer 22 and a print result 23.

The thin client terminal 20 is a terminal to access PC 10 via the network 3. Here, the thin client terminal 20 includes the converted data 106. The thin client terminal 20 includes a function to access PC 10 through the network 3. Moreover, the thin client terminal 20 includes a function to receive the converted data 106 via the network 3. Furthermore, the thin client terminal 20 includes a function to store the converted data 106 in the removal storage medium 21. There is no limitation in model of the thin client terminal 20 as far as the thin client terminal 20 includes the above-mentioned functions.

The converted data 106 which is stored in the thin client terminal 20 is transmitted from the PC 10 to the thin client terminal 20, when the file 101 is printed.

The removal storage medium 21 is a storage medium which is detachable to and from the thin client terminal 20 and the printer 22. As an example of the storage medium, a USB (Universal Serial Bus) memory, a SD card (Secure Digital memory card), a DVD-R (Digital Versatile Disk Recordable), a DVD-RAM (Digital Versatile Disk Random Access Memory) and an IC (Integrated Circuit) card are exemplified. Regarding the IC card, any one of the contact type IC card and the non-contact type IC card are available. An external storage device, which can access the thin client terminal 20 and the printer 22 through an USB (Universal Serial Bus) cable, IEEE (The Institute of Electrical and Electronics Engineers, Inc.) 1394 cable or the like, can be applicable to the removal storage medium 21. However, removal storage medium is not limited to the above examples. There is no limitation in a model of the removal storage medium 21 as far as the removal storage medium 21 includes enough capacity to store the converted data 106. It may be preferable that a removal storage medium which includes a fingerprint authentication function is applied to the removal storage medium 21 in order to ensure security.

That is, data is exchanged between the thin client terminal 20 and the printer 22 with a method except communication. Here, data is exchanged between the thin client terminal 20 and the printer 22 via the removal storage medium 21. As one of other methods, a QR (Quick Response) code (registered trademark) can be applicable. For example, the thin client terminal 20 generates the QR Code (registered trademark) from the converted data 106 and indicates the generated QR Code (registered trademark). The printer 22 reads the QR Code (registered trademark) indicated by the thin client terminal 20 and generates the converted data 106 based on the read QR Code (registered trademark). In this case, the QR Code (registered trademark) corresponds to the removal storage medium 21.

The printer 22 prints the file 101.

The printer 22 includes the converted data 106, the data converting unit 105, the intermediate file 104, the control information 102, a control information checking unit 221, a print data generating unit 222, print data 223 and a printing unit 224.

Further, the printer 22 can include a PC which has the same configuration as the PC 10 has. For example, the PCs 10 are arranged both in the server room 1 and in the destination place 2 so that the PCs 10 in the destination place and the printer 22 work cooperatively. At least one PC 10 is required to be arranged at the destination place 2. In this case, the PC 10 in the destination place 2 includes the converted data 106, the data converting unit 105, the intermediate file 104 and the control information 102. The printer 22 includes the control information checking unit 221, the print data generating unit 222, the print data 223 and the printing unit 224.

The converted data 106 is read from the removal storage medium 21 which is attached to the printer 22.

The data converting unit 105 is similar to the data converting unit 105 which is installed in the PC 10. That is, the data converting unit 105 is a means for inversely converting (decrypting and extracting) the converted data 106 to generate the control information 102 and the intermediate file 104. Here, in response to a notification on permit of printing issued by the control information checking unit 221, the data converting unit 105 provides the print data generating unit 222 with the intermediate file 104. Further, the data converting unit 105 can be an external data converting device which is arranged outside the PC 10 and the printer 22. However, the data converting unit 105 is not limited to the above examples.

The control information checking unit 221 is a means for checking expiration date, the number of times of printing and an ID of a printer which is permitted to print, which are included in the control information 102, to judge whether or not printing is permitted. Based on the judgment on the printing, the control information checking unit 221 notifies the data converting unit 105 of whether the printing is permitted or not. The control information checking unit 221 can directly notifies the printing unit 224 of whether the printing is permitted or not based on the judgment on propriety of printing. Moreover, the control information checking unit 221 notifies the print data generating unit 222 of whether the printing is permitted or not based on the judgment on propriety of printing.

The print data generating unit 222 is a means for generating the print data 223 based on the intermediate file 104. Further, the print data generating unit 222 can generate the print data 223 in response to the notification on permit of the printing issued by the control information checking unit 221, based on the intermediate file 104.

The print data 223 can be printed by the printing unit 224 and includes contents of the file 101.

The printing unit 224 is a means for printing the print data 223. Further, the printing unit 224 can print the print data 223 and output the print result 23, in response to the notification on permit of the printing issued by the control information checking unit 221.

The print result 23 is the result of printing the file 101 by the printer 22. Here, the print result 23 is an output of the printing unit 224.

Next, a detailed configuration of the data converting unit 105 will be described.

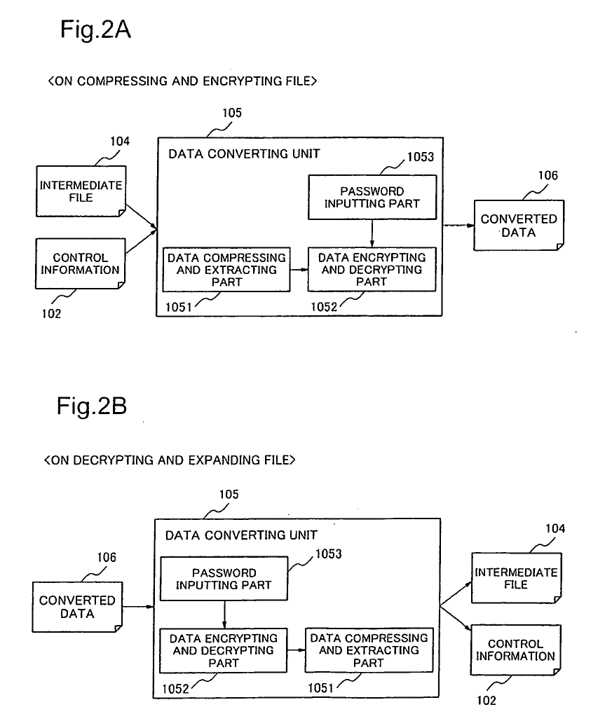

With reference to FIG. 2A and FIG. 2B, the data converting-unit 105 includes a data compressing and extracting part 1051, a data encrypting and decrypting part 1052 and a password inputting part 1053. Further, FIG. 2A shows an exemplary configuration in which a file is compressed and encrypted and FIG. 2B shows an exemplary configuration in which a file is decrypted and extracted.

When compressing and encrypting the file, the data compressing and extracting part 1051 compresses the control information 102 and the intermediate file 104 to generate compressed data. Moreover, the data compressing and extracting part 1051 transfers the compressed data to the data encrypting and decrypting part 1052. Moreover, the data compressing and extracting part 1051 extracts data which is received from the data encrypting and decrypting part 1052, to regenerate the control information 102 and the intermediate file 104, when decrypting and extracting the file are carried out. Furthermore, the data compressing and extracting part 1051 outputs the control information 102 and the intermediate file 104 which are regenerated.

When compressing and encrypting the file, the data encrypting and decrypting unit 1052 encrypts the compressed data which is received from the compressing and extracting part 1051, by using a password which is received from the password inputting part 1053. The data encrypting and decrypting unit 1052 outputs the converted data 106 which are generated through the encryption. Moreover, when decrypting and extracting the file, the data encrypting and decrypting unit 1052 decrypts the converted data 106 by using a password which is received from the password inputting part 1053. Furthermore, the data encrypting and decrypting part 1052 transfers the decrypted data to the data compressing and extracting part 1051.

The password inputting part 1053 transfers the password which is used for encryption and decryption by the data encrypting and decrypting part 1052, into the data encrypting and decrypting part 1052.

Next, details of the control information 102 will be described.

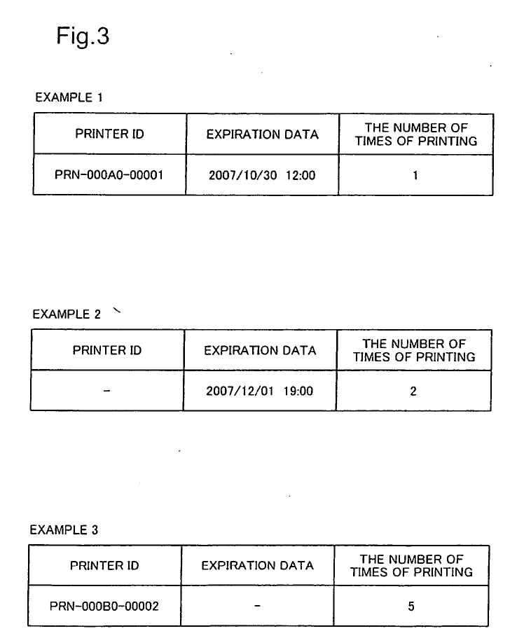

With reference to FIG. 3, the control information 102 includes a printer ID, an expiration date and the number of times of printing.

The printer ID means an ID of a printer which is permitted to print the file 101. Symbol “−” as which the printer ID is denoted means that the file can be printed by every printer. That is, the symbol “−” as which the printer ID is denoted means that every model of printers is applicable.

The expiration date means time limit for printing the file 101. The file 101 can not be printed after the expiration date. Symbol “−” as which the expiration date is denoted means that the expiration date is not set. That is, the symbol “−” as which the expiration date is denoted means that the expiration date is indefinite.

The number of times of printing means an available number of printing the file 101. The number of times of printing which is one or more is set.

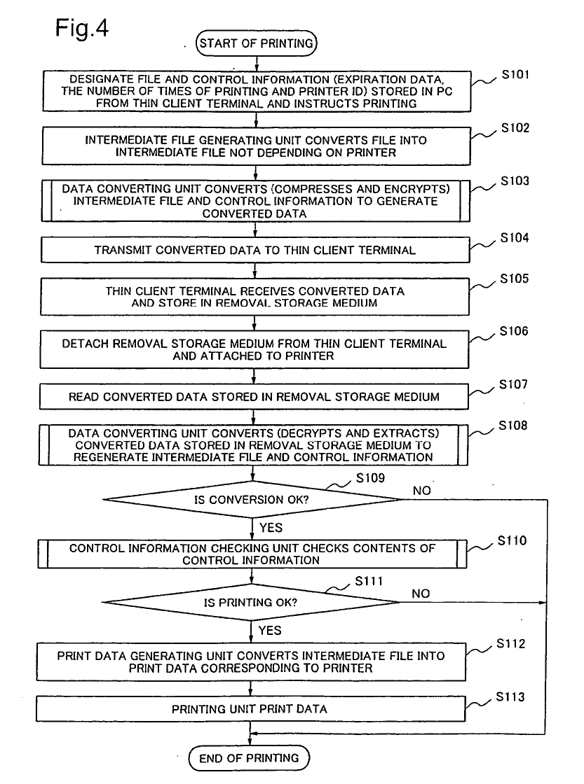

Next, operations according to the first exemplary embodiment will be described in detail, with reference to a flowchart shown in FIG. 4.

(1) Step S101

First, a user designates the file 101 and the control information 102 (expiration date, the number of times of printing and printer ID) in the PC 10 by using the thin client terminal 20, and also requests printing. As a result, the thin client terminal 20 designates the file 101 and the control information 102 (expiration date, the number of times of printing and printer ID) in the PC 10. Moreover, the thin client terminal 20 instructs the PC 10 to print the designated file 101. In response to the instruction issued by the thin client terminal 20, the PC 10 starts process of the printing.

(2) Step S102

The intermediate file generating unit 103 of the PC 10 converts the file 101 into the intermediate file 104 which does not depend on a printer. That is, the intermediate file generating unit 103 generates the intermediate file 104 which is in a form not depending on a model of a printer, with reference to the file 101 which is designated by the thin client terminal 20.

(3) Step S103

Afterward, the data converting unit 105 of the PC 10 converts (compresses and encrypts) the control information 102 and the intermediate file 104 to generate the converted data 106. That is, the data converting unit 105 generates the converted data 106, based on a predetermined conversion rule with reference to the control information 102 and the intermediate file 104. Further, the data converting unit 105 can deletes the control information 102 and the intermediate file 104, after the data converting unit 105 generates the converted data 106.

(4) Step S104

After the converted data 106 is generated, the PC 10 transmits the converted data 106 to the thin client terminal 20 via the network 3.

(5) Step S105

The thin client terminal 20 receives the converted data 106 from the PC 10 via the network 3. Then, the thin client terminal 20 stores the converted data 106 in the removal storage medium 21 which is attached to the thin client terminal 20.

(6) Step S106

A user detaches the removal storage medium 21 from the thin client terminal 20 and attaches the removal storage medium 21 to the printer 22.

(7) Step S107

The printer 22 reads the converted data 106 which is stored in the attached removal storage medium 21. When the removal storage medium 21 includes an authentication function using such as a password, a fingerprint or the like, the data converting unit 105 carries out the authentication process.

(8) Step S108

Afterward, the data converting unit 105 of the printer 22 inversely converts (decrypts and extracts) the converted data 106 to regenerate the control information 102 and the intermediate file 104.

(9) Step S109

The data converting unit 105 continues the process if the conversion is OK (the conversion is permitted), after the authentication process by using the password and/or the fingerprint is carried out. On the other hand, after the data converting unit 105 carries out the authentication process by using the password and/or the fingerprint, the data converting unit 105 stops the process if the conversion is prohibited due to unfair usage of the password. At this time, the converted data 106 which is stored in the removal storage medium 21 is held as it is. That is, when the conversion is prohibited, the printer 22 ends the printing.

(10) Step S110

The control information checking unit 221 of the printer 22 checks contents of the control information 102 generated by the data converting unit 105. That is, if the number of times of printing in the control Information 102 is greater than one, the control information checking unit 221 determines that the printing is OK (the printing is permitted). Afterward, if the number of times of printing in the control information 102 is greater than one, the control information checking unit 221 decrements the number of times of printing in the control information 102. Then, the control information checking unit 221 transfers the control information 102 and the intermediate file 104 to the data converting unit 105. The data converting unit 105 converts (compresses and encrypts) the control information 102 and the intermediate file 104 which are transferred from the control information checking unit 221, to generate the converted data 106. The data converting unit 105 overwrites the converted data 106 which is stored in the removal storage medium 21, with the converted data 106 which is generated. On the other hand, if the number of times of printing in the control information 102 is one, the printer 22 deletes the converted data 106 which is stored in the removal storage medium 21. Further, if a problem is found through checking the control information 102 by the control information checking unit 221, the printer 22 deletes similarly the converted data 106 which is stored in the removal storage medium 21. For example, when the printer ID does not correspond to the printer 22 or term of the printer ID expires, the printing is prohibited. In this case, the printer 22 deletes similarly the converted data 106 which is stored in the removal storage medium 21.

(11) Step S111

The printer 22 continues the process, if results of the checking show that the printing is OK (the printing is permitted). On the other hand, the printer 22 ends the printing if results of the checking show that the printing is prohibited.

(12) Step S112

The print data generating unit 222 of the printer 22 converts the intermediate file 104 into the print data 223 corresponding to the printer 22. That is, the print data generating unit 222 generates the print data 223 which is in a form corresponding to a model of the printer 22, with reference to the intermediate file 104. Further, after generating the print data 223, the print data generating unit 222 can delete the intermediate file 104.

(13) Step S113

The printing unit 224 of the printer 22 prints the print data 223 which the print data generating unit 222 generates, and outputs the print result 23.

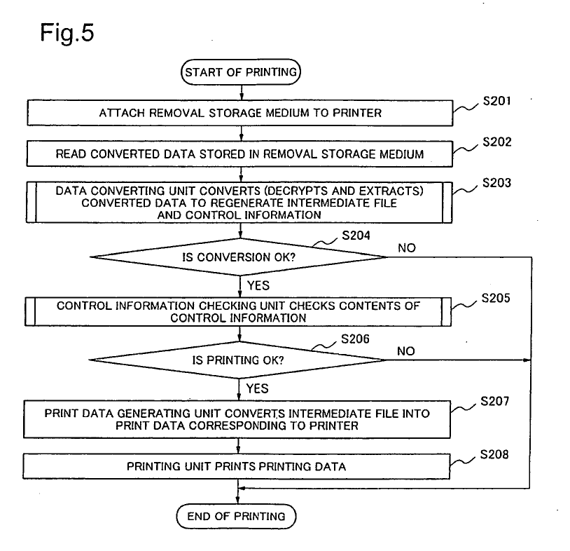

Next, operations which are conducted when the number of times of printing remains will be described with reference to a flowchart shown in FIG. 5.

(1) Step S201

First, a user attaches the removal storage medium 21 to the printer 22. The following processes (Steps S202 to S208) are identical with the processes of Steps S107 to S113 in FIG. 4.

(2) Step S202

That is, when the removal storage medium 21 is attached to the printer 22, the printer 22 reads the converted data 106 which is stored in the removal storage medium 21. At the point of time, if the removal storage medium 21 includes the authentication function using such as the password, the fingerprint or the like, the data converting unit 105 carries out the authentication process.

(3) Step S203

The data converting unit 105 of the printer 22 inversely converts (decrypts and extracts) the converted data 106 to regenerate the control information 102 and the intermediate file 104.

(4) Step S204

When the data converting unit 105 determines that the conversion is OK (the conversion is permitted) after carrying out the authentication process by using the password, the fingerprint or the like, the data converting unit 105 continues the process. On the other hand, when the data converting unit 105 determines that the conversion is prohibited due to unfair usage of the password after carrying out the authentication process by using the password, the fingerprint or the like, the converted data 106 in the removal storage medium 2 is held as it is. That is, if the conversion is prohibited, the printer 22 ends the printing.

(5) Step S205

The control information checking unit 221 of the printer 22 checks contents of the control information 102 which is generated by the data converting unit 105. On carrying out the checking, the control information checking unit 221 determines that the printing is OK (the printing is permitted) if the number of times of printing of the control information 102 is not smaller than one. Moreover, if the number of times of printing of the control information 102 is greater than one, the control information checking unit 221 decrements the number of times of printing of the control information 102. Afterward, the control information checking unit 221 transfers the control information 102 in which the number of times of printing is decremented and the intermediate file 104 to the data converting unit 105. The data converting unit 105 converts (compresses and encrypts) the control information 102 and the intermediate file 104 which are transferred from the control information checking unit 221, to generate the converted data 106. The printer 22 overwrites the converted data 106 which is stored in the removal storage medium 21, with the converted data 106 which is generated. On the other hand, if the number of times of printing in the control information 102 is one, the printer 22 deletes the converted data 106 which is stored in the removal storage medium 21. Further, if a problem is found through checking the control information 102 by the control information checking unit 221, the printer 22 deletes similarly the converted data 106 which is stored in the removal storage medium 21.

(6) Step S206

The printer 22 continues the process when results of the checking the control information shows that the printing is OK (the printing is permitted). On the other hand, the printer 22 ends the printing if it is determined that the printing is prohibited.

(7) Step S207

The print data generating unit 222 of the printer 22 converts the intermediate file 104 into the print data 223 corresponding to a model of the printer 22. That is, the print data generating unit 222 generates the print data 223 which is in a form corresponding to a model of the printer 22, with reference to the intermediate file 104. Further, after generating the print data 223, the print data generating unit 222 can delete the intermediate file 104.

(8) Step S208

The printer 22 prints the print data 223 and obtains the print result 23. That is, the printing unit 224 outputs the print result 23 based on the print data 223.

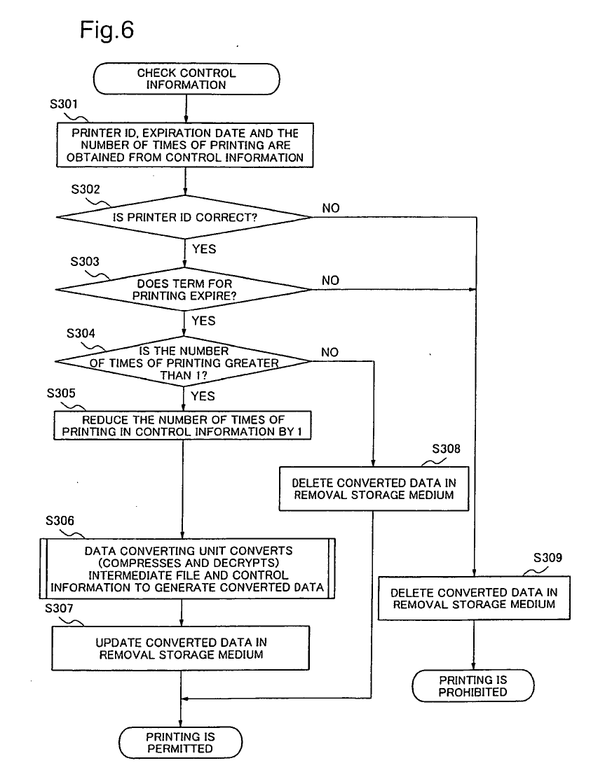

Next, with reference to a flowchart shown in FIG. 6, operations of the control information checking unit 221 (Step S110 in FIG. 4) will be described in detail.

(1) Step S301

First, the control information checking unit 221 receives the printer ID, the expiration date and the number of times of printing from the control information 102.

(2) Step S302

The control information checking unit 221 compares the received printer ID with the printer ID of the printer 22. Then, the control information checking unit 221 judges whether or not the received printer ID accords with the printer ID of the printer 22.

(3) Step S303

Next, when the received printer ID accords with the printer ID of the printer 22 or when the symbol “−” is designated as the printer ID, the control information checking unit 221 checks the expiration date.

(4) Step S304

When term for printing does not expire or when the symbol “−” is designated as the expiration date of the control information 102, the control information checking unit 221 checks the number of times of printing.

(5) Step S305

If the number of times of printing is greater than one, the control information checking unit 221 reduces the number of times of printing which is held in the control information 102, by one. Moreover, the control information checking unit 221 instructs the data converting unit 105 to update the converted data 106 which is stored in the removal storage medium 21.

(6) Step S306

The data converting unit 105 converts (compresses and encrypts) the control information 102 which is updated by the control information checking unit 221, and the intermediate file 104 to generate the converted data 106.

(7) Step S307

The data converting unit 105 overwrites the converted data 106 which is stored in the removal storage medium 21, with the converted data 106 which is generated. That is, the data converting unit 105 updates the converted data 106 which is stored in the removal storage medium 21. Then, the data converting unit 105 notifies the control information checking unit 221 of the updating. When the control information checking unit 221 receives the notification from the data converting unit 105, the control information checking unit 221 determines that the printing is OK (the printing is permitted). That is, the information checking unit 221 determines that the printing is OK (the printing is permitted) with regard to the judgment on the printing.

(8) Step S308

If the number of times of printing is one, the control information checking unit 221 instructs the data converting unit 105 to delete the converted data 106 which is stored in the removal storage medium 21. Then, the data converting unit 105 deletes the converted data 106 which is stored in the removal storage medium 21. Moreover, the data converting unit 105 notifies the control information checking unit 221 of the deletion. When the control information checking unit 221 receives the notification from the data converting unit 105, the control information checking unit 221 determines that the printing is OK (the printing is permitted). That is, the information checking unit 221 determines that the printing is OK (the printing is permitted), with regard to the judgment on the printing. Further, the control information checking unit 221 can directly delete the converted data 106 which is stored in the removal storage medium 21.

(9) Step S309

If the received printer ID does not accord with the printer ID of the printer 22 or if term for the printing is found to expire as a result of the check on the expiration date, the control information checking unit 221 instructs the data conversion part 105 to delete the converted data 106 which is stored in the removal storage medium 21. Then, the data converting unit 105 deletes the converted data 106 which is stored in the removal storage medium 21. Moreover, the data converting unit 105 notifies the control information checking unit 221 of the deletion. When the control information checking unit 221 receives the notification from the data converting unit 105, the control information checking unit 221 determines that the printing is prohibited. That is, the information checking unit 221 determines that the printing is prohibited with regard to the judgment on the printing. Further, the control information checking unit 221 can delete directly the converted data 106 which is stored in the removal storage medium 21.

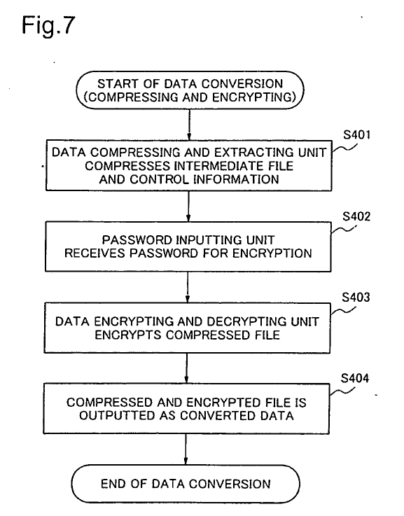

With reference to a flowchart shown in FIG. 7, operations for compression and encryption (Step S103 of FIG. 4 and Step S306 of FIG. 6) carried out by the data converting unit 105 will be described in detail below.

(1) Step S401

First, the data compressing and extracting part 1051 of the data converting unit 105 compresses the control information 102 and the intermediate file 104.

(2) Step S402

Next, the password inputting part 1053 of the data converting unit 105 receives the password for encryption which is inputted by a user. Then, the password inputting part 1053 notifies the data encrypting and decrypting part 1052 of the password for encryption.

(3) Step S403

Moreover, the data encrypting and decrypting part 1052 of the data converting unit 105 encrypts the file which is compressed as mentioned above, based on the password for the encryption.

(4) Step S404

The data converting unit 105 outputs the compressed and encrypted file as the converted data 106. Further, the data converting unit 105 can delete the intermediate file 104, after outputting the converted data 106.

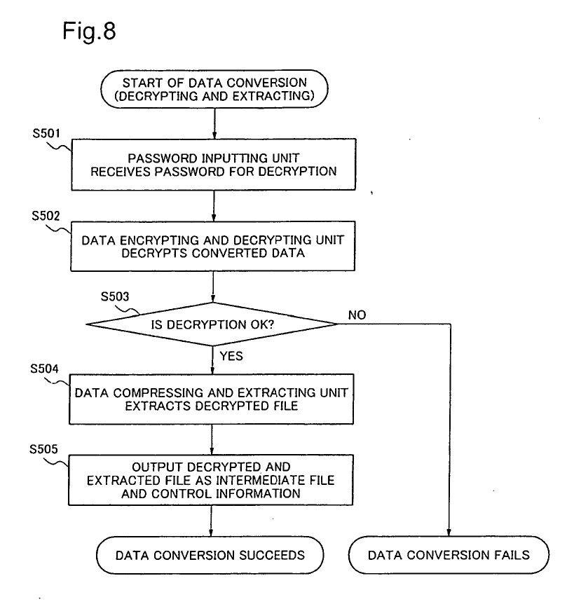

With reference to a flowchart of FIG. 8, operations for decryption and extraction (Step S108 of FIG. 4) carried out by the data converting unit 105 will be described in detail below.

(1) Step S501

First, the password inputting part 1053 of the data converting unit 105 receives the password for decryption which is inputted by a user. Then, the password inputting part 1053 notifies the data encrypting and decrypting part 1052 of the received password. Further, the password for decryption can be identical with the password for encryption.

(2) Step S502

Next, the data encrypting and decrypting part 1052 of the data converting unit 105 decrypts the converted data 106 based on the password for decryption.

(3) Step S503

When the data converting unit 105 succeeds in decrypting the converting data 106, data converting unit 105 continues the process. On the other hand, if the data converting unit 105 can not decrypt the converting data 106 due to the unfair usage of the password, the data converting part 105 fails in converting data and then, ends the process.

(4) Step S504

Upon reception of the decrypted file from the data encrypting and decrypting unit 1052, the data compressing and extracting part 1051 of the data converting unit 105 extracts the decrypted file.

(5) Step S505

The data converting unit 105 outputs the decrypted and extracted file as the control information 102 and the intermediate file 104.

Next, effects of the first exemplary embodiment will be described.

The first effect is that it is unnecessary to install a printer driver on the PC or the thin client terminal, even if a printer which is requested to print changes. The reason is that the intermediate file for printing is generated in a form which does not depend on a printer when a file is printed according to the thin client system. Consequently, it is possible to localize the process which depends on a model of the printer, inside the printer.

The second effect is that even if the printer is not connected to the Intranet, the printer can print the file. The reason is that the removal storage medium is used, as a means for transferring data from the PC to the printer.

The third effect is that it is possible to prevent printing by a wrong printer by using the removal storage medium.

The fourth effect is that it is possible to decrease an amount of network traffic for printing. The reason is that when the PC transmits data to the thin client terminal, the data is compressed so as to reduce an amount of traffic.

The fifth effect is that even if a user loses the removal storage medium by mistake, it is impossible for other people to print data which is stored in the removal storage medium. One reason is that the data is encrypted and consequently, it is impossible to print the data if the password is not recognized. Other reason is that if term for the printing expires, the data is deleted automatically when the data is printed. Further other reason is that any printer except the permitted printer can not print.

The sixth effect is that it is possible to designate the number of times of printing. The reason is that a mechanism is installed in which the control information holds the number of times of printing and the number of times of printing is reduced whenever the printer prints the data.

The seventh effect is that it is possible to prevent wrongly taking out the print data. The reason is that it is possible to set the system so that a printer except the permitted printer cannot print.

### A SECOND EXEMPLARY EMBODIMENT

A configuration according to a second exemplary embodiment will be described in detail below.

According to the second exemplary embodiment, a PC in a server room transmits directly print data to a printer arranged at a destination place and makes the printer print the print data, in response to print instructions which is issued by the thin client terminal. Moreover, checking the control information is not carried out. Therefore, the removal storage medium 21, the control information 102 and the control information checking unit 221 are unnecessary, according to the second exemplary embodiment.

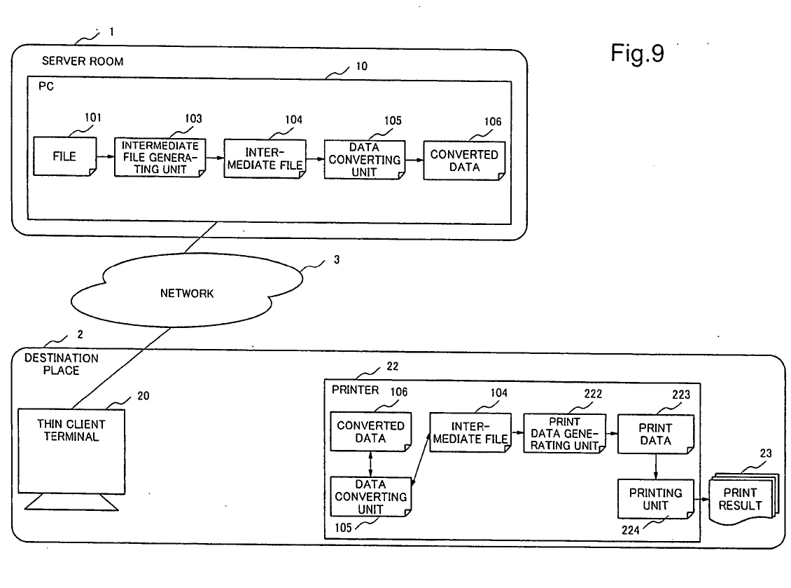

With reference to FIG. 9, a printing system includes the server room 1, the destination place 2 and the network 3, according to the second exemplary embodiment.

The server room 1 is a place where the PC 10 is arranged to work as the thin client system. That is, the server room 1 includes at least one PC 10. Further, the server room 1 can be paraphrased with a group of servers including a plurality of PCs.

The PC 10 is used as a PC which works in the thin client system. Further, any type of PCs such as a blade PC and a virtual PC is available. That is, as an example of the PC 10, any model of PCs is available. It is preferable that the PC 10 is a server working in the thin client system. However, PC 10 is not limited to the above examples.

The PC 10 includes the file 101, the intermediate file generating unit 103, the intermediate file 104, the data converting unit 105 and the converted data 106.

The file 101, the intermediate file generating unit 103 and the intermediate file 104 are the same as the first exemplary embodiment has.

The data converting unit 105 is a means for converting (compressing and encrypting) the intermediate file 104 to generate the converted data 106. Moreover, the data converting unit 105 can also convert inversely (decrypt and extract) the converted data 106 to regenerate the intermediate file 104. The data compressing and extracting part 1051, the data encrypting and decrypting part 1052 and the password inputting part 1053 (refer to FIG. 2A and FIG. 2B) of the data converting unit 105 are the same as the first exemplary embodiment has, except for that there is no input and output of the control information 102.

The intermediate file 104 is converted (compressed and encrypted) by the data converting unit 105 and consequently, the converted data 106 is generated.

The destination place 2 is different in location from the server room 1. The destination place 2 is connected with the server room 1 via the network 3. Further, the destination place 2 can be paraphrased with a group of terminals working in the thin client system.

The destination place 2 includes the thin client terminal 20, the printer 22 and the print result 23.

The thin client terminal 20 can access PC 10 via the network 3. There is no other limitation in a model of the thin client terminal 20 as far as the thin client terminal 20 has a function to access the PC 10 via the network 3.

The printer 22 prints the file 101.

The printer 22 includes the converted data 106, the data converting unit 105, the intermediate file 104, the print data generating unit 222, the print data 223 and the printing unit 224.

Further, the printer 22 can includes a PC having the same configuration as the PC 10 of the second exemplary embodiment has. For example, the PCs 10 are arranged both in the server room 1 and in the destination place 2 so that the PCs 10 in the destination place and the printer 22 can work cooperatively. At least one PC 10 can be arranged at the destination place. In this case, the PC 10 in the destination place 2 includes the converted data 106, the data converting unit 105 and the intermediate file 104. The printer 22 includes the print data generating unit 222, the print data 223 and the printing unit 224.

The converted data 106 is transmitted from the PC 10 to the printer 22 via the network 3.

The data converting unit 105 is identical to the data converting unit 105 which is installed in the PC 10. That is, the data converting unit 105 is a means for converting inversely (decrypting and extracting) the converted data 106 to regenerate the intermediate file 104. Further, the data converting unit 105 may be an external data converting apparatus which is arranged outside the PC 10 and the printer 22.

The print data generating unit 222 is a means for generating the print data 223 based on the intermediate file 104.

The printing unit 224 is a means for printing the print data 223.

The print result 23 is a result of printing contents of the file 101 printed by the printer 22.

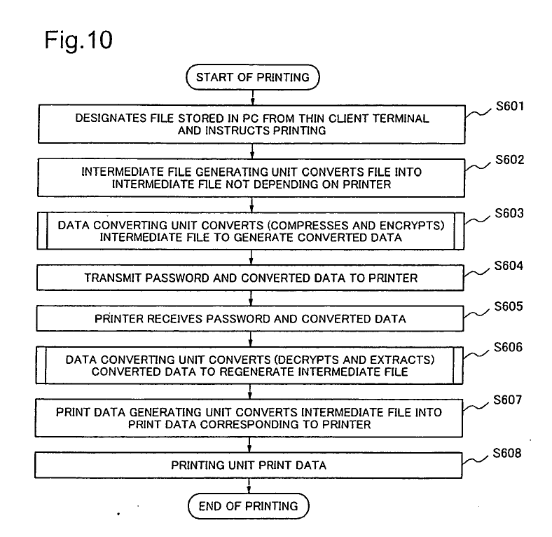

Next, with reference to a flowchart shown in FIG. 10, operations of the second exemplary embodiment will be described in detail.

(1) Step S601

First, the thin client terminal 20 designates the file 101 which the PC 10 holds and then, instructs the PC 10 to print the designated file 101. In response to the instruction issued by the thin client terminal 20, the PC 10 starts processes related to the printing.

(2) Step S602

The intermediate file generating unit 103 of the PC 10 refers to the file 101 which is designated by the thin client terminal 20. The intermediate file generating unit 103 converts the file 101 into a form which does not depend on a model of a printer to generate the intermediate file 104.

(3) Step S603

The data converting unit 105 of the PC 10 compresses the intermediate file 104. Afterward, the data converting unit 105 encrypts the compressed intermediate file 104 based on the password inputted by a user. That is, the data converting unit 105 compresses and encrypts the intermediate file 104 according to a predetermined conversion rule and consequently, generates the converted data 106, based on the intermediate file 104. Further, the data converting unit 105 can deletes the intermediate file 104, after generating the converted data 106.

(4) Step S604

The PC 10 transmits the password which is used for encrypting the intermediate file 104, and the converted data 106 to the printer 22. The password is also used for decryption. That is, the PC 10 transmits both the password for decryption and the converted data 106 to the printer 22. Further, as a procedure for transmitting the password to the printer, the PC 10 can use any type of key exchange method such as the Diffie-Hellman key exchange method.

(5) Step S605

The data converting unit 105 of the printer 22 receives the password and the converted data 106 from the PC 10.

(6) Step S606

The data converting unit 105 of the printer 22 decrypts the converted data 106 based on the password received from the PC 10. Then, the data converting unit 105 extracts the converted data 106 which is decrypted. As mentioned above, the data converting unit 105 converts inversely (decrypts and extracts) the converted data 106 to regenerate the intermediate file 104.

(7) Step S607

The print data generating unit 222 of the printer 22 generates the print data 223 which is in a form corresponding to a model of the printer 22, with reference to the intermediate file 104. Further, after generating the print data 223, the print data generating unit 222 can deletes the intermediate file 104.

(8) Step S608

The printing unit 224 of the printer 22 prints the print data 223 and outputs the print result 23. As a result, the printer 22 obtains the print result 23.

Next, an effect of the second exemplary embodiment will be described.

The first effect is that it is unnecessary to install a printer driver on a PC and a thin client terminal, even if a printer which is requested to print changes. The reason is that the intermediate file for printing is generated in a form which does not depend on a printer and consequently, it is possible to localize process which is conducted according to a model of a printer inside the printer, when a file is printed according to the thin client system.

The second effect is that it is possible to decrease an amount of network traffic for printing. The reason is that when data is transmitted to a thin client terminal from a PC, the data is compressed to reduce an amount of traffic.

### THE THIRD EXEMPLARY EMBODIMENT

Next, the third exemplary embodiment will be described. The third exemplary embodiment includes configurations of the first exemplary embodiment and the second exemplary embodiment.

That is, the third exemplary embodiment includes a configuration in which process which has to be conducted according to a model of a printer is localized inside the printer, and a configuration in which a removal storage medium for exchanging data is used as mentioned above.

The third exemplary embodiment will be described specifically in the following.

When a file is printed according to the thin client system, first, the file which is stored in a PC is converted into the intermediate file which is in a form not depending on a printer. Then, the intermediate file is compressed and encrypted. That is, the intermediate file is converted into converted data. Afterward, the converted data is transmitted to the thin client terminal from the PC.

The thin client terminal stores the received data in the removal storage medium.

The removal storage medium is detached from the thin client terminal. Then, the removal storage medium is attached to the printer. Afterward, the printer reads the data which is stored in the removal storage medium. Then, the printer decrypts and extracts the read data. As a result, the printer obtains the intermediate file. Afterward, the printer converts the intermediate file into a form which enables own printing unit to print, and prints the converted file.

An effect of the third exemplary embodiment will be described in the following.

(1) The first effect is that it is unnecessary to install a printer driver on a PC and a thin client terminal, even if a printer which is requested to print changes.

(2) A PC and a thin client terminal can print a file, even if a desired printer is not connected to a network of the thin client system including the PC and the thin client terminal.

(3) It is possible to directly attach the removal storage medium to a desired printer so that the desired printer can print a file which is stored in the removal storage medium. According to the configuration, it is possible to prevent a PC and a thin client terminal from designating a wrong printer and prevent the wrong printer from printing the file.

(4) It is possible to decrease an amount of network traffic, since data which flows through a network for printing a file is compressed.

(5) Even if a user loses a removal storage medium by mistake, it is impossible for other people to print data which is stored in the removal storage medium.

(6) It is possible to designate the number of times of printing.

(7) It is possible to prevent wrongly taking out the print data.

### A FOURTH EXEMPLARY EMBODIMENT

Next, the fourth exemplary embodiment will be described.

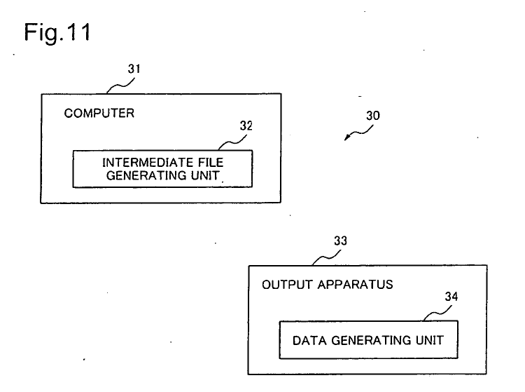

As shown in FIG. 11, a data outputting system 30 includes a computer 31 and an output apparatus 33, according to the fourth exemplary embodiment. The computer 31 includes an intermediate file generating unit (intermediate file generating means) 32. The output apparatus 33 includes a data generating unit (data generating means) 34.

According to the data outputting system 30, the intermediate file generating unit 32 of the computer 31 converts a file as a processing object into an intermediate file which is in a form not depending on a model of output apparatus. The data generating unit 34 of the output apparatus 33 converts the intermediate file into data which is in a form corresponding to a model of the output apparatus.

According to the fourth exemplary embodiment, a file stored in the computer 31 is processed by the output apparatus 33 with a method described in the following. For example, the computer 31 converts the file of the processing object into the intermediate file which is in a form not depending on a model of the output apparatus. Afterward, the output apparatus 33 which receives the intermediate file converts the intermediate file into data which is in a form corresponding to a model of the output apparatus 33. The output apparatus 33 processes the converted data.

As mentioned above, the file of the processing object is converted to the intermediated file and then, the intermediate file is transferred to the output apparatus 33 by the computer 31, according to the fourth exemplary embodiment. Therefore, it is not necessary that the computer 31 converts the file which is supplied to the output apparatus, into a form corresponding to a model of the output apparatus. As a result, it is possible that the computer can make the desired printer process the file, even if the computer does not have a driver, for example, which corresponds to a model of the output apparatus.

### A FIFTH EXEMPLARY EMBODIMENT

The fifth exemplary embodiment will be described in the following.

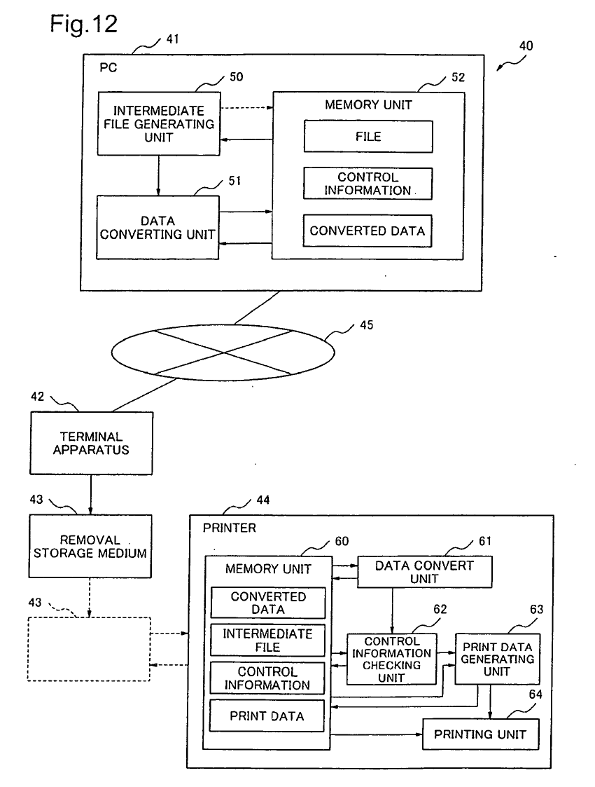

As shown in FIG. 12, a printing system 40 includes a PC (computer) 41, a terminal apparatus 42, a removal storage medium 43 and a printer (output apparatus) 44, according to the fifth exemplary embodiment.

The PC 41 is connected to the terminal apparatus 42 via a communication network 45. For example, the PC 41 is corresponding to a server working in a thin client system. The PC 41 includes an intermediate file generating unit (intermediate file generating means) 50, a data converting unit 51 and a memory unit 52.

Various data, files and programs are stored in the memory unit 52. For example, a file which is transmitted from the terminal apparatus 42 and a file which the PC 41 generates according to instructions issued by the terminal apparatus 42 are stored in the memory unit 52. Moreover, the memory unit 52 stores control information which is similar to the control information 102 of the first exemplary embodiment.

The intermediate file generating unit 50 has a function to convert a file of a printing object into the intermediate file shown in the following. That is, the intermediate file generating unit 50 reads the file of the printing object which is designated, for example, by the terminal apparatus 42 or the like, from the memory unit 52. The intermediate file generating unit 50 converts the file of the printing object into the intermediate file. The intermediate file is in a form which does not depend on a model of a printer, like the intermediate file 104 of the first and the second exemplary embodiments. For example, the intermediate file is supplied from the intermediate file generating unit 50 to the data converting unit 51. The intermediate file may be stored in the memory unit 52.

The data converting unit 51 has a function to convert the intermediate file and the control information into converted data which is in a predetermined form for communication. For example, when the data converting unit 51 detects that the intermediate file is generated by the intermediate file generating unit 50, the data converting unit 51 obtains the intermediate file from the intermediate file generating unit 50 or the memory unit 52. The data converting unit 51 reads the control information from the memory unit 52. The data converting unit 51 converts the intermediate file and the control information into the converted data like the data converting unit 105 of the first exemplary embodiment. That is, the data converting unit 51 has the same configuration (refer to FIG. 2A and the descriptions) as the data converting unit 105 of the first exemplary embodiment has.

The converted data which is generated by the data converting unit 51 is transmitted by a transmitting unit (not shown) of the PC 41 to the terminal apparatus 42 via the communication network 45. Further, the converted data can be read from the memory unit 52 and can be transmitted to the terminal apparatus 42, after the converted data is stored in the memory unit 52 of the PC 41.

The terminal apparatus 42 has a function to exchange data or the like with the PC 41 via the communication network 45. The terminal apparatus 42 includes a memory unit (not shown). The terminal apparatus 42 stores the converted data which is transmitted by the PC 41 in the memory unit. The terminal apparatus 42 can directly store the converted data which is transmitted by the PC 41 in the removal storage medium 43.

The removal storage medium 43 is detachable with respect to the terminal apparatus 42 and the printer 44. The removal storage medium 43 has the same configuration as the removal storage medium 21 of the first exemplary embodiment has.

The printer 44 includes a memory unit 60, a data converting unit 61, a control information checking unit 62, a print data generating unit (print data generating means) 63 and a printing unit 64.

The printer 44 includes a function to read the converted data which is stored in the removal storage medium 43 and a function to store the converted data which is read from the removal storage medium 43, in the memory unit 60.

The data converting unit 61 includes a function to read the converted data from the memory unit 60 and a function to convert the converted data which is read from the memory unit 60 into the intermediate file and the control information. The data converting unit 61 has the same configuration, for example, as the data converting unit 105 of the printer 22 of the first exemplary embodiment has (for example, refer to FIG. 2B and the description). The data converting unit 61 stores the intermediate file and the control information in the memory unit 60.

Moreover, when the data converting unit 61 detects that the control information of the memory unit 60 is overwritten with the control information checking unit 62, which will be described below, the data converting unit 61 reads both the control information and the intermediate file corresponding to the control information from the memory unit 60. The data converting unit 61 has a configuration (for example, the configuration similar to the data converting unit 51 of the PC 41) in which the control information and the intermediate file which are read from the memory unit 60 are converted into the converted data. A writing unit (not shown) of the printer 44 overwrites the converted data of the removal storage 43 with the converted data which is generated by the data converting unit 61.

The control information checking unit 62 judges whether or not printing is permitted, based on the control information. For example, when the control information checking unit 62 detects that the intermediate file and the control information are generated by the data converting unit 61, the control information checking unit 62 reads the generated control information from the memory unit 60. Then, the control information checking unit 62 works just as the control information checking unit 221 of the first exemplary embodiment does (for example, refer to FIG. 6 and the descriptions). That is, the control information checking unit 62 judges whether or not printing the intermediate file, that is, the file of the printing object, based on the control information which is transmitted together with the intermediate file from the PC 41. The control information checking unit 62 has a function to update the control information and a function to overwrite the control information which is stored in the memory unit 60 with the updated control information, like the control information checking unit 221 of the first exemplary embodiment. Moreover, the control information checking unit 62 has a function to delete the converted data of the removal storage medium 43 when the control information checking unit 62 determines that printing is prohibited, like the control information checking unit 221 of the first exemplary embodiment.

The print data generating unit 63 has a function to read the intermediate file which is based on the file of the printing object, from the memory unit 60, after the control information checking unit 62 judges whether or not printing is OK. The print data generating unit 63 converts the read intermediate file into print data. The print data is in a form corresponding to a model of the printer 44. The print data are stored, for example, in the memory unit 60.

Further, the print data generating unit 63 can generate the print data without relation to the judgment by the control information checking unit 62. That is, when the print data generating unit 63 detects that the intermediate file is generated by the data converting unit 61, the print data generating unit 63 reads the intermediate file from the memory unit 60. The print data generating unit 63 converts the read intermediate file into the print data. The print data generating unit 63 can include the configuration mentioned above.

The printing unit 64 reads the print data from the memory unit 60 and prints the print data, after the printing unit 64 detects that the control information checking unit 62 determines that printing is OK, and detects that the print data generating unit 63 generates the print data.

Since the fifth exemplary embodiment has the above-mentioned configuration, the fifth exemplary embodiment has following effects. That is, according to the printing system 40 of the fifth exemplary embodiment, the file of the printing object which is transmitted from the PC 41 to the printer 44 is converted into the intermediate file which is in a form not depending on a model of a printer. Therefore, regardless of a model of a printer to which the file of the printing object is transmitted, the PC 41 can transmit the file of the printing object to the printer to make the printer print the file of the printing object. That is, the PC 41 can make a desired printer print the file of the printing object without installing the driver corresponding to a model of a printer.

According to the fifth exemplary embodiment, the PC 41 transfers the intermediate file to the printer 44 via the terminal apparatus 42 and the removal storage medium 43. Therefore, even if the printer 44 is not connected to the communication network 45, the intermediate file (file of printing object) can be transferred from the PC 41 to the printer 44. That is, it becomes possible to print the file of the printing object by using the printer 44 which is not connected to the communication network 45.

Moreover, according to the fifth exemplary embodiment, the removal storage medium 43 is used to transfer the intermediate file. Therefore, for example, a user who requests printing detaches the removal storage medium 43 from the terminal apparatus 42 and attaches the removal storage medium 43 to the printer 44 which is a print outputting object. That is, a user who requests printing moves to a place where the printer which is the print outputting object is located and directly attaches the removal storage medium 43 to the printer. The work mentioned above can prevent a wrong printer from conducting printing.

According to the fifth exemplary embodiment, the PC 41 does not transmit the intermediate file to the communication network 45 just as it is. The PC 41 converts the intermediate file into converted data and transmits the converted data to the communication network 45. Since the intermediate file is compressed, the converted data can reduce an amount of communication traffic through the communication network 45.

Moreover, the converted data is generated through encrypting the intermediate file. Furthermore, the converted data includes the control information. While the removal storage medium 43 is used for transferring the file, it is possible to prevent information leakage of the file, according to the fifth exemplary embodiment. That is, it is supposed that a user who carries the removal storage medium 43 loses the removal storage medium 43. In such a case, even if other person who finds the removal storage medium 43 tries to print the file stored in the removal storage medium 43, the file can not be decrypted if the password is not recognized. Moreover, even if the file is decrypted, the file (data) stored in the removal storage medium 43 is deleted automatically before printing, if it is found that the printer has no printing permit or if term for printing expires based on the control information. As mentioned above, it is possible to prevent the information leakage of the file.

According to the fifth exemplary embodiment, the control information includes the number of times of printing and the number of times of printing decreases whenever the printing is carried out. The above mentioned operation also contributes to prevention of the information leakage of the file greatly.

Further, according to the fifth exemplary embodiment, the control information includes the identification information on the printer which is permitted to print, the expiration date for printing and the number of times of printing. However, the control information may include any one or any two of the identification information of printer, the expiration date for printing and the number of times of printing.

While the file (data) is transferred from the terminal apparatus 42 to the printer 44 by using the removal storage medium 43 according to the fifth exemplary embodiment, the file (data) can be transferred from the terminal apparatus 42 to the printer 44 with a method except communication. For example, the file (data) can be transferred from the terminal apparatus 42 to the printer 44 by using an indication code which includes a two-dimensional code such as QR Code described in the first exemplary embodiment.

### A SIXTH EXEMPLARY EMBODIMENT

The sixth exemplary embodiment will be described in the following. According to the above mentioned fifth exemplary embodiment, the intermediate file is transferred from the PC 41 to the printer 44 via the terminal apparatus 42 and the removal storage medium 43. According to the sixth exemplary embodiment, the intermediate file is directly transferred from the PC 41 to the printer 44 via the communication network 45. The configuration of the sixth exemplary embodiment is same as that of the fifth exemplary embodiment except the above mentioned point.

The sixth exemplary embodiment has similar effects as the fifth exemplary embodiment has. That is, according to the sixth exemplary embodiment, the PC 41 converts a file of a printing object into a file which is in a form not depending on a model of a printer and outputs the converted data to a printer of a print outputting object. For this reason, even if the PC 41 does not have a driver of the printer of the print outputting object, the PC 41 can make the printer of the print outputting object print the file of the printing object.

The file which PC 41 outputs to the printer 44 is compressed. For this reason, it is possible to decrease communication capacity of the file on the communication network 45.

The file which PC 41 outputs to the printer 44 includes the control information. Moreover, the printer 44 has a function to judge whether or not printing is permitted based on the control information. For this reason, security against the information leakage is ensured.

### A SEVENTH EXEMPLARY EMBODIMENT

The seventh exemplary embodiment will be described in the following. The seventh exemplary embodiment is simplified one of the fifth and the sixth exemplary embodiments. That is, according to the fifth and the sixth exemplary embodiments, the data outputted from the PC 41 to the communication network 45 is based on the intermediate file and the control information. However, according to the seventh exemplary embodiment, the control information is not used. That is, the control information is not stored in the memory unit 52 of the PC 41. The data converting unit 51 of the PC 41 converts only the intermediate file which is generated by the intermediate file generating unit 50, into converted data.

The printer 44 does not include the control information checking unit 62 in the fifth and the sixth exemplary embodiments. Moreover, the data converting unit 61 of the printer 44 decrypts and extracts the converted data which is received from the PC 41. As a result, the data converting unit 61 generates the intermediate file, based on the converted data. The print data generating unit 63 converts the intermediate file into the print data which is in a form corresponding to a model of the printer 44, after the print data generating unit 63 detects that the data converting unit 61 generates the intermediate file. The printing unit 64 prints the print data.

The configuration of the seventh exemplary embodiment is the same as the fifth or the sixth exemplary embodiment has except the above mentioned configuration. The seventh exemplary embodiment has the same effect as the fifth and the sixth exemplary embodiments have. That is, the PC 41 converts the file of the printing object into the file which is in a form not depending on a model of a printer and transmits the converted data to the printer 44. For this reason, even if the PC 41 does not have a driver of the printer of the print outputting object, it is possible for PC 41 to make the printer of the print outputting object print the file of the printing object.

Moreover, it is possible to decrease the communication capacity of the file on the communication network 45, since the PC 41 outputs the compressed data to the communication network 45.

Furthermore, since the control information is not used according to the seventh exemplary embodiment, it is possible to simplify the configuration of the seventh exemplary embodiment compared with the fifth or the sixth exemplary embodiments. Further, while the control information is not used, the information leakage is prevented, since the file which is transmitted from the PC 41 to the printer 44 is encrypted.

Further, the present invention is not limited to the first to the seventh exemplary embodiments above described. The present invention can adopt various exemplary embodiments. For example, while the printing system, and the computer and the printer as components of the printing system are exemplified according to the first to the seventh exemplary embodiments, the present invention is applicable to, for example, an indication system or a data processing system. For example, in an example of the indication system, “printer” is paraphrased with “indication apparatus such as a display” or “projection device such as a projector”. Moreover, “print” is paraphrased with “indication”. Further, a mobile terminal is applicable to the indication apparatus.

Meanwhile, in an example of the data processing system, “printer” is paraphrased with “external processor” and “print” is paraphrased with “data processing”. As an example of the external processor, a PC or the like arranged at the destination place is exemplified.

A printing system according to the eighth exemplary embodiment includes:

a computer which is arranged in a server room; and

a printer which is arranged outside of a server room, and a thin client terminal which is arranged outside of a server room.

The computer includes:

an intermediate file generating unit to convert a file of a printing object into an intermediate file which is in a form not depending on a printer model; and

a data converting unit to convert the intermediate file into converted data.

The printer includes:

a data converting unit which inversely converts the converted data to the intermediate file;

a print data generating unit to convert the intermediate file into print data; and

a printing unit which prints the print data.

The thin client terminal access the computer via the network. The thin client terminal designates a file of a printing object in the computer and supplies the converted data without communicating with the printer directly. Even if the thin client terminal doesn't have the printer driver which corresponds to a printer, The thin client terminal make the printer print the file of the printing object.

A printing method according to the ninth exemplary embodiment includes:

A step in which the computer converts a file of a printing object to generate an intermediate file which is in a form not depending on a printer model, and converts the intermediate file into the converted data; and

A step in which the printer receives the converted data, and inversely converts the converted data into the intermediate file, and generates the print data with reference to the intermediate file, and prints the print data; and

A step in which the thin client terminal designates a file of a printing object in the computer, and then supplies the converted data without communicating with the printer directly, and the printer print the file of the printing object, based on the converted data.

A computer according to the tenth exemplary embodiment includes:

an intermediate file generating unit to convert a file of a printing object into an intermediate file which is in a form not depending on a printer model; and

a data converting unit to convert the intermediate file into converted data.

A printer according to the eleventh exemplary embodiment includes:

a data converting unit which inversely converts the converted data to the intermediate file;

a print data generating unit to convert the intermediate file into print data; and

a printing unit which prints the print data.

And now, in some cases, a user who is at a destination place tries to connect a thin client terminal with a server which is arranged in a server room by using the communication network such as a wireless LAN (Local Area Network)/VPN (Virtual Private Network). In this case, even if a printer is arranged near the thin client terminal, the print data cannot be transmitted to the printer when the printer is not connected to the network (Intranet) which is included in the thin client system. That is, disadvantage that the printer can not print occurs.

In contrast, according to the present invention, it is possible to transfer a file of a printing object to a printer by using a removal storage medium. For this reason, it is possible that, for example, the file of the printing object is transferred from a server to the printer which is not connected to a communication network of the thin client system. As a result, it is possible that the file of the printing object which is stored in the server can be printed also by the printer which is not connected with the server.

While the invention has been particularly shown and described with reference to exemplary embodiments thereof, the invention is not limited to these exemplary embodiments. It will be understood by those of ordinary skill in the art that various changes in form and details can be made therein without departing from the spirit and scope of the present invention as defined by the claims.

Further, it is the inventor's intention to retain all equivalents of the claimed invention even if the claims are amended during prosecution.

What is claimed is:

1. A printing system, comprising:
a computer; and
a printer which prints print data,
wherein
said computer includes an intermediate file generating unit to convert a file of a printing object into an intermediate file which is in a form not depending on a printer model,
and wherein
said printer includes a print data generating unit to convert said intermediate file into print data which is in a form corresponding to a printer model.

2. The printing system according to claim 1,
wherein
said computer transmits said intermediate file to said printer via a communication network.

3. The printing system according to claim 1, further comprising:
a terminal apparatus which is connected to said computer via a communication network; and
a removal storage medium in which said terminal apparatus stores said intermediate file which is transmitted from said computer to said terminal apparatus via said communication network,
wherein
said intermediate file is transferred to said printer via said removal storage medium.

4. The printing system according to claim 1,
wherein
said intermediate file is transferred from said computer to said printer, together with control information on printing said file of said printing object,
and wherein
said printer further includes a control information checking unit which judges whether or not printing said file of said printing object is permitted, based on said control information.

5. The printing system according to claim 4,
wherein
said control information includes at least one of identification information on a printer which is permitted to print said file of said printing object, expiration date which indicates time limit for printing said file of said printing object and the number of times of printing which indicates an available number of printing said file of said printing object.

6. The printing system according to claim 3,
wherein
said intermediate file is transferred from said computer to said printer via said removal storage medium, together with control information including the number of times of printing which indicates an available number of printing said file of said printing object,
wherein
said printer includes a control information checking unit which judges whether or not printing said file of said printing object is permitted, based on said control information,
and wherein
if said number of printing in said control information is greater than one, said control information checking unit reduces said number of printing by one, and if said number of printing in said control information is one, said control information checking unit deletes said intermediate file from said removal storage medium.

7. The printing system according to claim 3,
wherein
said intermediate file is transferred from said computer to said printer via said removal storage medium, together with control information including at least one of identification information on a printer which is permitted to print said file of said printing object and expiration date for printing said file of said printing object,
wherein
said printer includes a control information checking unit which judges whether or not printing said file of said printing object is permitted, based on said control information,
and wherein
if said control information checking unit determines that said printing is not permitted based on said identification information on said printer in said control information, or if said control information checking unit determines that term for printing said file of said printing object expires based on said expiration date of said control information, said control information checking unit deletes said intermediate file from said removal storage medium.

8. The printing system according to claim 1,
wherein
said computer further includes a data converting unit to convert said intermediate file into converted data which is in a predetermined form for communication,
wherein
said printer further includes a data converting unit which inversely converts said converted data to said intermediate file,
and wherein
said intermediate file is transferred from said computer to said printer in a state of said converted data.

9. The printing system according to claim 4,
wherein
said computer further includes a data converting unit to convert said intermediate file into converted data which is in a predetermined form for communication, together with said control information,
wherein
said printer further includes a data converting unit which inversely converts said converted data to said intermediate file and said control information,
and wherein
said intermediate file and said control information are transferred from said computer to said printer in a state of said converted data.

10. The printing system according to claim 8,
wherein
said data converting unit of said computer includes:
a password inputting part which receives a password;
a data compressing part which compresses said intermediate file; and
a data encrypting part which encrypts said compressed intermediate file by using said password,
wherein
said data converting unit outputs said compressed and encrypted intermediate file as said converted data,
and wherein
said data converting unit of said printer, including:
a password inputting part which receives said password;
a data decrypting part which decrypts said converted data based on said password; and
a data extracting part which extracts decrypted data to generate said intermediate file.

11. The printing system according to claim 9,
wherein
said data converting unit of said computer includes:
a password inputting part which receives a password;
a data compressing part which compresses said intermediate file and said control information; and
a data encrypting part which encrypts said compressed intermediate file and said compressed control information by using said password,
wherein
said data converting unit outputs said intermediate file and said control information which are compressed and encrypted, as said converted data,
and wherein
said data converting unit of said printer, including:
a password inputting part which receives a password;
a data decrypting part which decrypts said converted data based on said password; and
a data extracting part which extracts decrypted data to generate said intermediate file and said control information.

12. A printing system, comprising:
a computer; and
a printer which prints print data,
wherein
said computer includes an intermediate file generating means for converting a file of a printing object into an intermediate file which is in a form not depending on a printer model,
and wherein
said printer includes a print data generating means for converting said intermediate file into print data which is in a form corresponding to a printer model.

13. A computer, comprising:
an intermediate file generating unit to convert a file of a printing object into an intermediate file which is in a form not depending on a printer model.

14. The computer according to claim 13, further comprising:
a data converting unit to convert said intermediate files into converted data which is in a predetermined form for communication.

15. The computer according to claim 14,
wherein
said data converting unit converts control information on printing said file of said printing object together with said intermediate file into converted data which is in said predetermined form.

16. The computer according to claim 14,
wherein
said data converting unit includes:
a password inputting part which receives a password;
a data compressing part which compresses said intermediate file; and
a data encrypting part which encrypts said compressed intermediate file by using of said password.

17. A computer, comprising:
an intermediate file generating means for converting a file of a printing object into an intermediate file which is in a form not depending on a printer model.

18. A printer, comprising:
a print data generating unit to convert a intermediate file which is in a form not depending on a printer model into print data which is in a form corresponding to a printer model.

19. The printer according to claim 18, further comprising:
a control information checking unit which judges whether or not printing said print data is permitted based on control information which is received together with said intermediate file.

20. The printer according to claim 18, further comprising:
a data converting unit which converts converted data which is in a predetermined form for communication into said intermediate file.

21. The printer according to claim 20,
wherein
said data converting unit includes:
a password inputting part which receives a password;
a data decrypting part which decrypts said converted data based on said password; and
a data extracting part which extracts decrypted data to generate said intermediate file and control information.

22. A printer, comprising:
print data generating means for converting an intermediate file which is in a form not depending on a printer model into print data which is in a form corresponding to a printer model.

23. A printing method, comprising:
converting a file of a printing object into an intermediate file which is in a form not depending on a printer model;
transmitting said intermediate file to a communication network;
converting said intermediate file into print data which is in a form corresponding to a printer model by said printer; and
printing said print data.

24. The printing method according to claim 23, comprising:
transmitting said intermediate file to a predetermined printer via said communication network.

25. The printing method according to claim 23, comprising:
transmitting said intermediate file to a predetermined terminal apparatus via said communication network;
storing said intermediate file in a removal storage medium by said terminal apparatus; and
reading said intermediate file from said removal storage medium by said printer.

26. The printing method according to claim 23, further comprising:
outputting said intermediate file together with control information on printing said file of said printing object into said communication network; and
judging whether or not printing said print data is permitted, said print data being generated from said intermediate file, based on said control information by said printer,
wherein
if it is determined that printing said print data is permitted, said printer prints said print data.

27. The printing method according to claim 26,
wherein
said control information includes at least one of identification information on a printer which is permitted to print said file of said printing object, expiration date which indicates time limit for printing said file of said printing object and the number of times of printing which indicates an available number of printing said file of said printing object.

28. The printing method according to claim 25, comprising:
transferring said intermediate file together with control information which includes the number of times of printing which indicates an available number of printing said file of said printing object to a predetermined printer via said removal storage medium;
judging whether or not printing said file of said printing object is permitted based on said control information by said printer; and
reducing said number of printing of said control information by one if said number of printing is greater than one, and said printer deletes said intermediate file from said removal storage medium if said number of printing is one.

29. The printing method according to claim 25, comprising:
outputting said intermediate file together with control information which includes at least one of expiration date of said file of said printing object and identification information on said printer which is permitted to print said file of said printing object, to said printer via said removal storage medium;
judging whether or not printing said file of said printing object is permitted based on said control information by said printer; and
deleting said intermediate file from said removal storage medium, if said printer determines that said printing is not permitted based on said identification information of said printer in said control information, or if said printer determines that term for printing said file of said printing object expires based on said expiration date in said control information.

30. The printing method according to claim 23, further comprising:
converting said intermediate file into converted data which is in a predetermined form for communication;
outputting said converted data to said communication network; and
converting said converted data into said intermediate file by said printer,
wherein
said intermediate file is transferred from said computer to said printer in a state of said converted data.

31. The printing method according to claim 30, further comprising:
compressing said intermediate file;
encrypting said compressed intermediate file based on a received password;
outputting said compressed and encrypted intermediate file into said communication network as said converted data;
decrypting said converted data based on said password by said printer; and
extracting said decrypted data to generate said intermediate file.

32. A data outputting system, comprising:
a computer; and
an output apparatus which outputs data,
wherein
said computer includes an intermediate file generating unit which converts a file of a processing object into an intermediate file which is in a form not depending on a model of said output apparatus,
and wherein
said output apparatus includes a data generating unit to convert said intermediate file into data which is in a form corresponding to a model of said output apparatus.

33. The data outputting system according to claim 32,
wherein
said computer transmits said intermediate file to said output apparatus via a communication network.

34. The data outputting system according to claim 32, comprising:
a terminal apparatus which is connected to said computer via a communication network; and
a removal storage medium in which said terminal apparatus stores said intermediate file which is transferred from said computer to said terminal apparatus via said communication network,
wherein
said intermediate file is transferred to said output apparatus by using said removal storage medium.

35. The data outputting system according to claim 32,
wherein
said intermediate file is transferred from said computer to said output apparatus together with control information on process said file of said processing object,
and wherein
said output apparatus including a control information checking unit which judges whether or not processing said file of said processing object is permitted based on said control information.

36. The data outputting system according to claim 35,
wherein
said control information includes at least one of identification information on said output apparatus which is permitted to process said file of said processing object, expiration date which indicates time limit for processing said file of said processing object and the number of processing which indicates an available number of processing said file of said processing object.

37. The data outputting system according to claim 34,
wherein
said intermediate file is transferred from said computer to said output apparatus via said removal storage medium, together with control information which includes the number of processing which indicates an available number of processing said file of said processing object,
wherein
said output apparatus includes,
a control information checking unit which judges whether or not processing said file of said processing object is permitted based on said control information,
and wherein
said control information checking unit reduces said number of processing of said control information by one if said number of processing is greater than 1, and said control information checking unit deletes said intermediate file from said removal storage medium if said number of processing is one.

38. The data outputting system according to claim 34,
wherein
said intermediate file is transferred from said computer to said output apparatus via said removal storage medium, together with control information which includes at least one of expiration date of said file of said processing object and identification information on an said output apparatus which is permitted to process said file of said processing object,
wherein
said output apparatus includes,
a control information checking unit which judges whether or not said processing said file of said processing object based on said control information,
and wherein
said control information checking unit deletes said intermediate file from said removal storage medium, if said control information checking unit determines that said processing is not permitted based on said identification information of said output apparatus in said control information, or if said control information checking unit determines that term for said processing said file of said processing object expires based on said expiration date of said control information.

39. The data outputting system according to claim 32,
wherein
said computer further includes,
a data converting unit to convert said intermediate file into converted data which is in a predetermined form for communication,
wherein
said output apparatus further includes,
a data converting unit which inversely converts said converted data into said intermediate file,
and wherein
said intermediate file is transferred from said computer to said output apparatus in a state of said converted data.

40. The data outputting system according to claim 35,
wherein
said computer further includes,
a data converting unit which converts said intermediate file into converted data which is in a predetermined form for communication together with said control information,
wherein
said output apparatus further includes,
a data converting unit which inversely converts said converted data into said intermediate file and said control information,
and wherein
said intermediate file and said control information are transferred from said computer to said output apparatus in a state of said converted data.

41. The data outputting system according to claim 39,
wherein
said data converting unit of said computer includes,
a password inputting part which receives a password;
a data compressing part which compresses said intermediate file; and
a data encrypting part which encrypts said compressed intermediate file by using said password,
wherein
said data converting part outputs said compressed and encrypted intermediate file as said converted data,
and wherein
said data converting unit of said output apparatus includes,
a password inputting part which receives said password;
a data decrypting part which decrypts said converted data based on said password; and
a data extracting part which extracts said decrypted data to generate said intermediate file.

42. The data outputting system according to claim 40,
wherein
said data converting unit of said computer includes,
a password inputting part which receives a password;
a data compressing part which compresses said intermediate file and said control information; and
a data encrypting part which encrypts said compressed intermediate file and said compressed control information by using said password,
wherein
said data converting unit outputs said intermediate file and said control information which are compressed and encrypted as said converted data,
and wherein
said data converting unit of said output apparatus includes,
a password inputting part which receives said password;
a data decrypting part which decrypts said converted data based on said password; and
a data extracting part which extracts said decrypted data to generate said intermediate file and said control information.

43. A data outputting system, comprising:
a computer; and
an output apparatus which outputs data,
wherein
said computer includes an intermediate file generating means for converting a file of a processing object into an intermediate file which is in a form not depending on a model of output apparatus,
and wherein
said output apparatus includes a data generating means for converting said intermediate file into data which is in a form corresponding to a model of output apparatus.
